(19) United States
(12) Patent Application Publication
(10) Pub. No.: US 2006/0150625 A1
(43) Pub. Date: Jul. 13, 2006

(54) Natural forces power system

(76) Inventor: Clifford Hiram Behrens, Biloxi, MS (US)

Correspondence Address: CLIFFORD HIRAM BEHRENS, 10032 SHADY PLACE, BILOXI, MS, 39532-7800, US

(21) Appl. No.: 11/037,765

(22) Filed: Jan. 12, 2005

(51) Int. Cl. F03B 17/02

(52) U.S. Cl. 60/495

(57) ABSTRACT

The two forces used are gravity and the atmospheric pressure. Gravity initiates the power phase by causing the water to fall from the elevated sealed water tank 10 to turn the turbine 32. The water lowers to 33.95 feet above ground level within the sealed water tank 10. A vacuum forms above the water. The water flows from the turbine into the elevated open water tank 46 to the level whereby its water outlet valve 26B opens. This affords a passage back into the elevated sealed water tank 10, through the check valve 40 and the manual shut-off valve 42. This initiates the recovery phase. The atmospheric pressure of 14.7 psi on the elevated open water tank 46 forces the water back into the sealed water tank 10 to relieve the vacuum. This pressure is capable to move the water up to 33.95 feet. Here it has only to move it up to 26.95 feet, realizing a 20.6 percent reserve force. With the water level again attaining maximum height in the sealed water tank 10, it is again released to repeat the cycle.

### BACKGROUND OF THE INVENTION

This invention relates to the generation of electrical power. The idea of this invention occurred to me while taking a physics class. To the best of my knowledge, this system is without precedent. I have no related applications and I know of no similar prior art approaches. Currently energy is produced primarily with hydroelectric plants, coal and other carbon fuels, nuclear energy, windmills, and to a limited extent solar power and natural thermal sources. All of these have their disadvantages. These either depend on favorable weather or cause pollution or other environmental harm. Some are limited in scope or present a waste disposal problem. My invention has none of these disadvantages. It consists of a simple structure. Its operation is likewise simple.

The forces used are gravity and the atmospheric pressure. A most positive aspect of this invention is that these forces are inexhaustible and do not diminish in force while used. While this invention is presented as a source of electrical energy, it is not restricted to that. It may be used for any other purpose such as driving pumps. It is designed to operate independently, without outside power. This fact makes it ideal for employment in remote regions, for example, to maintain a charge on a bank of batteries. Multiple large units could be employed to supply power to electrical grids. Its size is not restricted to certain capacities. This system is designed for use with water; however, fluids of other weights could be used for whatever purpose with proportional adjustments. The force of atmospheric pressure at sea level is normally 14.7 pounds per square inch. This equates to 2116.8 pounds of pressure per square foot (144 square inches in a square foot times 14.7 psi. equals 2116.8 pounds). However, while this force exists, it is not apparent until it encounters a vacuum. Gravity, the other primary force, needs no elaboration. Witness that the atmospheric pressure is the result of Earth's gravity. Both of these sources exert tremendous forces and are alternately employed in a two phase operation. It is my theory that the actions and reactions will occur as described under detailed descriptions. The disadvantage is that the power production is intermittent.

### BRIEF SUMMARY OF THE INVENTION

This system produces power economically, in a simple and environmentally friendly manner. The following descriptions, based on a randomly chosen size should not be construed to be its limit in size. Rather, it should only be viewed as an exemplification of a single embodiment thereof. For example, more realistic sizes of the system's water tanks would be with capacities of several 100,000 gallons each, with commensurate larger components for greater power production. However, while capacities may vary, the sealed higher water tank 10 must retain its 12-foot interior height, and its bottom at the 31.95-foot mark for optimum performance at sea level sites. Therefore, tank size increases are to be made in the dimensions of width, length or both. With water tank capacity increases the open lower water tank 46 must retain its bottom height at 18 feet above the ground level, while conforming proportionately in capacity increases with the sealed higher water tank 10 at sea level locations. At appreciable higher elevations the tank heights must be lowered to equate with the locality's lowered atmospheric pressure.

The system may operate in freezing zones with the addition of an anti-freeze. However, the addition of such could make a significant change from the water's specific gravity. Should that be the case then a comparable change would also be required in the heights of the water tanks.

Providing that the principles of operations hereafter described under detailed descriptions are met, the composition of the system's components may be altered as sound engineering may dictate. Accordingly, its scope should be determined not by its specifics and illustrations, but by the appended claims and their legal equivalents. In practice, minor adjustments to the calculated measurements may be necessary. Means for adjustments, such as the turnbuckles, are provided throughout.

### BRIEF DESCRIPPTIONS OF THE SEVERAL DRAWINGS

FIG. 1/5 is a perspective view of the overall system.

FIG. 2/5 is shown representing the make-up of the identical float units 20A/20B, and that of the identical permanent magnets 22A/22B, plus other components such as the guide bars 18A/18B and the cables 24A/24B. These reference numbers are those used for these items in FIG. 1.

FIG. 3/5 shows the identical water outlet valve's two actuating levers in their vertical positions with the valve's disc in the open position. These valves are numbered 26A for the sealed water tank 10 and 26B for the open water tank 46.

FIG. 4/5 shows the water outlet valve's flaring and its magnet.

FIG. 5/5 is a view looking down into the opened water out-let valve.

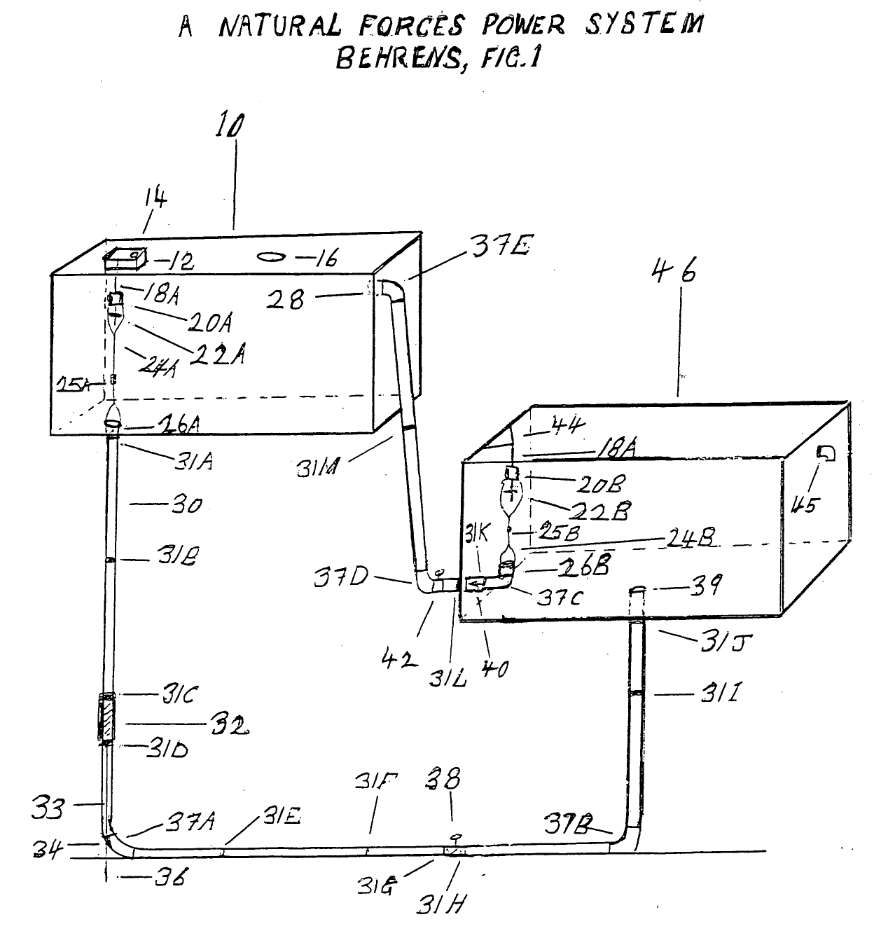

### DESCRIPTIONS—FIG. 1/5 THROUGH 5/5

In FIG. 1/5 identical units within the sealed water tank 10 and the open water tank 46 have The same reference numerals but different alphabetic suffixes: The sealed water tank 110's units have the suffix A,

And the open water tank 46's units use the suffix B. In other figures where suffixes are used they are self-explanatory. For the sake of brevity, all references to the sealed water tank 10 and to the open water tank 46 will henceforth simply read tank 10 and tank 46.

Reference FIG. 1/5:

This gives a perspective view of the overall system. The tanks 10 and 46 are drawn separated in a way to better illustrate their interrelationship. In practice these could be one on top of the other. Both tank 10 and tank 46 are constructed of steel and are conventionally built. All of the following height figures and references to the ground base level assumes a sea level location. Elevations appreciably different require compensating unit height adjustments.

Tank 10 has a capacity of 3,456 cubic feet for the purpose of this model. Its dimensions are 12 feet by 12 feet by 24 feet. Its capacity in gallons of water is 25,852.6 gallons. Tank 10's bottom measures 31.95 feet from the ground level. Tank 10 is sealed air-tight and has a top compartment 12 located 2.3 feet from its left end and centered between its sides. The entire bottom of compartment 12 is open to tank 10's interior. It is 12 inches in height, 18 inches wide and 24 inches long. Its capacity is 3 cubic feet for a water capacity of 22.4 gallons. Compartment 12's ceiling is 44.95 feet above the ground base level. Two inches from the top right end of compartment 12 is a water filler port, 14. It is six inches in diameter, and centered between compartment 12's sides. Filler port 14 is of conventional design with a closing cap secured with bolts around its perimeter. A sealing gasket is used. A one-half inch machine threaded hole passes through the cap's center to serve as a bleeder port. The hole is closed with a thread matching one-half inch machine bolt. The bolt's head is also gasket equipped.

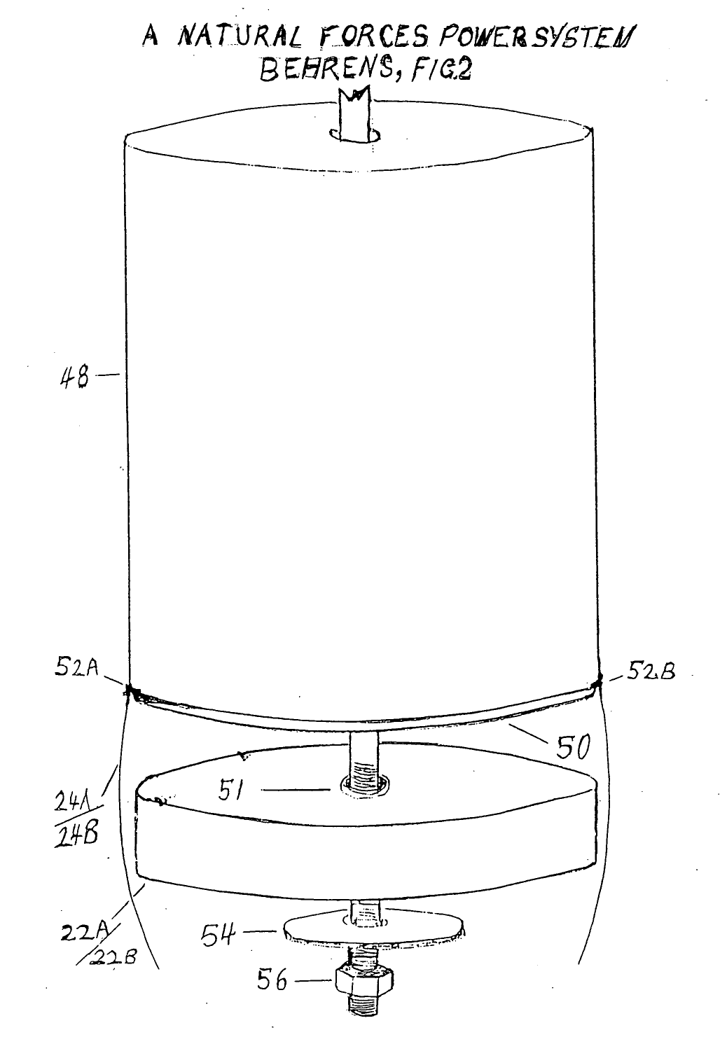

Situated seven inches from compartment 12's left end and centered is a guide bar 18A, with a diameter of one-half inch. It is welded to compartment 12's ceiling and extends straight downward for 30 inches. It is made of stainless steel (non-magnetic). Guide bar 18A is made to guide float unit 20A in its travels up and down. The float units 20A and 20B are identical and are treated in FIG. 2. Located on tank 10's top center is a manhole 16. It is of conventional design, including its gasket equipped bolted down cover. The lower ends of both guide bars 18A for tank 10 and 18B for tank 46 are machine threaded up to 10 inches. This is for the purpose of receiving the permanent magnets 22A for tank 10, and 22B for tank 46.

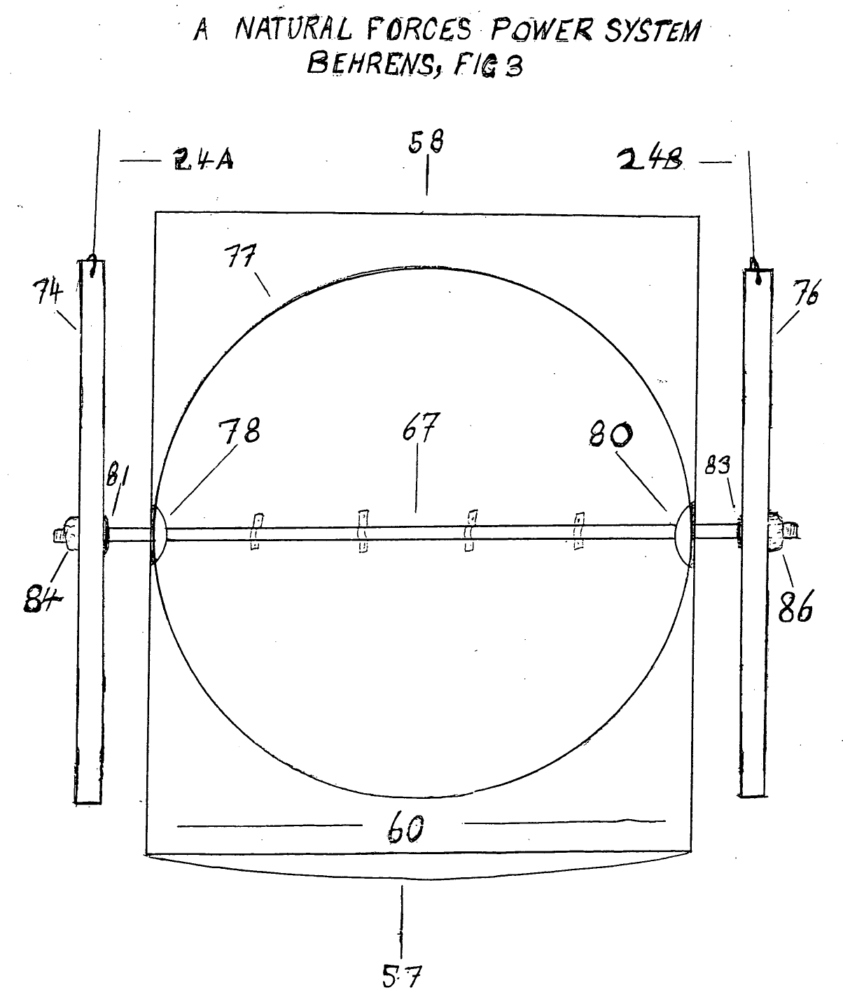

Tanks 10 and 46 have identical water outlet valves. These are 26A for tank 10 and 26B for tank 46. Each one, in its respective tank, is located on the tank's bottom directly beneath their guide bar's lower end. Each valve, 26A for tank 10, and 26B for tank 46 is connected via a 0.0625 inch stainless steel cable, 24A for tank 10, and 24B for tank 46, to its respective float unit. Cables 24A and 24B are equipped with an adjustable turnbuckle, 25A for tank 10, and 25B for tank 46. Both water outlet valves 26A and 26B are flange coupled to their 10-inch pipe outlets, the piping 30. These valves are of the butterfly type with a 10-inch diameter and with a 12-inch height. Valves 26A and 26B are identical, and are described in FIGS. 3/5, 4/5, and 5/5. The flanged coupling 31A connects valve 26A to piping 30. Subsequent flange couplings at pipe joints are 31B through 31N. The 10-inch piping consists of 10-foot lengths throughout, for the purpose of this model except where shorter lengths are required to accommodate component installations.

A turbine 32 is situated 20 feet below tank 10 in the piping 30. It is of a conventional screw type with a series of 10 curved vanes. Each vane has a one-half inch hole through it at the mid-point between its base and its outer edge. This is its only non-conventional modification. Its spindle continues as an extension downward as a driveshaft 33. The driveshaft exits the piping through the sealed driveshaft outlet 34. Outside of the piping the driveshaft terminates with a splined end 36 for machinery connections. Pipe elbows 37A through 37E are used for the piping elbows. A manual shut-off valve 38 is installed in the horizontal ground level portion of piping 30.

Tank 46, the next major unit, has a guide bar support frame 44. It is triangular in shape with its vertex extending three feet over the tank from its base on top of the tank's left side, where it is welded to the tank. It is made of one and one-half inch angled stainless steel braces. Tank 46's guide bar 18B extends downward 37.275 inches from its attaching point at the vertex of the frame 44. Tank 46 is open to the atmosphere. It is covered with a screen to protect it from any debris, not illustrated. An over-flow port 45 is on the opposite end of the tank from the guide bar support frame 44. This over-flow port's bottom edge is 10 feet and seven inches above tank 46's bottom.

The dimensions of tank 46 are; height 12 feet, width 14 feet, length 24 feet. It has a capacity of 4,032 cubic feet, capable of holding 30,161 gallons of water, disregarding the Overflow port. The bottom of tank 46 is 18 feet above the ground base level. Immediately after tank 46's water outlet valve 26B is the one-way check valve 40. Following that is the shut-off valve 42. Thereafter the piping 30 completes its circuitous path back into tank 10. This ends the description of FIG. 1/5.

Reference FIG. 2/5:

This figure shows the details of the float units of tanks 10 and 46, and their related components. Tanks 10 and 46 have identical float units. In FIG. 1 these are numbered 20A for tank 10 and 20B for tank 46. They consist of a large upper portion which is a Styrofoam cylinder 48. Styrofoam is a trademark name. It is made of expanded rigid lightweight polystyrene plastic. Its dimensions: height 12 inches, diameter eight inches. A 0.75 inch hole, glazed for smoothness passes through its center lengthwise from top to bottom. The guide bars pass through these holes for the float units to travel up and down on.

Dow Chemical Company, 200 Larkin Center, 1605 Joseph Drive, Midland Mich. 48674, owns the Styrofoam trademark. This company is willing to make the upper part of the float unit. Beneath the Styrofoam portion of the float units is cemented an iron disc 50. It is protected with anti-corrosive paint. Its circular disc shape matches the Styrofoam portion, and it has a similar matching 0.75-inch hole through its center.

Styrofoam weighs two pounds per cubic foot, or 0.0185 ounce per cubic inch. The volume of each of the eight inch by 12-inch Styrofoam portion of the cylinder shaped float units 20A and 20B is 597.88 cubic inches. This is after subtracting the space of the center hole. It weighs 11.06 ounces.

Iron weighs 490 pounds per cubic foot, or 0.284 pounds per cubic inch. The volume of each of the circular iron disc 50's portion of the float units, with their diameters of eight inches, and a thickness of 0.125 inch, is 6.22 cubic inches. This is after subtracting the space occupied by the 0.75 inch hole. It weighs 28.26 ounces.

The weight of each of the float units 20A and 20B, consisting of Styrofoam and iron is 39.32 ounces. Adding to this the 25.4 ounces of their attached cables, 24A for tank 10 and 24B for tank 46, results in a total weight of 64.72 ounces, or 4.04 pounds for each of the float units. Cable weights include pins 52A and 52B, plus their attaching gear described later and their turnbuckles. The total volume of each float unit is 604.1 cubic inches. This is also the volume of water that each float unit displaces when completely submerged.

Water weighs 0.0361 pounds per cubic inch. Multiplying this times 604.1 equals 21.80801 pounds. Subtracting the weight of a float unit, which is 4.04 pounds, leaves 17.77 which is the force of buoyancy of each float unit.

On opposite sides of disc 50 and extending out horizontally 0.375 inch are welded stainless steel 0.25-inch pins, 52A and 52B. These have cotter key-holes at their outer ends. These accommodate the cables' eyelet terminals. Turnbuckles 25A and 25B are provided for fine Cable adjustments. The cables for both float units extend downward from each of their side connections for three feet to bypass and clear their permanent magnets, explained below. After that these side-attached cables join with a splice, leaving a single cable to continue downward. This single cable is joined with a splice to two other cables three feet above each valve's head. These two cables extend from the top of the vertical actuating levers from the left and right sides of the valves, forming an inverted wye configuration, to clear the valve heads. The tumbuckles are located on the single cable portion of each of the valve's cable set, 18 inches above the inverted wye figure. The distance from the bottom of the float units 20A and 20B to the top of the valves 26A and 26B is 10.16 feet. This is the distance the cables 24A and 24B cover. Both sets of cables include a built-in slack of one inch. Their lengths must be carefully measured because this is critical for proper operations.

Situated on the lower part of each guide bar is a permanent magnet, 22A for tank 10, and 22B for tank 46. Their center holes are embedded with an insert 51 which in turn has a center hole that is threaded to match that of the lower guide bar's threaded portion, whereby the permanent magnets are screwed onto and secured in their selected positions on the guide bars. A washer 54 and a nut 56 are tightly wedged up against the permanent magnets, rendering them stationary, yet adjustable. These permanent magnets conform to the float unit's cylindrical shape and diameter. Both of the permanent magnets 22A and 22B have a holding force of 17.27 pounds. For tank 10, the overall guide bar length is 30 inches. The top of its permanent magnet, which acts as the initial resting base for its float unit, must be 22 inches below the guide bar's attaching point on compartment 12's ceiling. Tank 46's guide bar length is 37.257 inches, and its permanent magnet's top must also be 22 inches below its guide bar attaching point. While much of this application is devoted to the system's float unit and permanent magnet means of controlling the water flow, it is strictly secondary, and other means are available. It is offered because it renders the overall system self-sufficient. It is optional. It should not detract from this invention's principal, that of harnessing the atmospheric pressure and gravity. In any case, larger systems would necessarily employ water level detectors and motor-driven water outlet valves, using electronic sensors and controls to manage the water's movements. For such installations I recommend the Grainger Industrial Supply Company, 3551, 1-55 South, West frontage Road, Jackson, Miss. This ends the description of FIG. 2/5.

Reference FIGS. 3/5, 4/5, and 5/5:

These figures are of different views of the identical water outlet valves for tanks 10 and 46. These two valves are identified in figure one as reference numbers 26A and 26B. Both valves remain submerged one foot in their respective tanks within the low water levels of two feet. The valves are flange fitted at the tank bottoms to piping 30. Each valve's disc 77 has an area of 78.54 square inches. The disc's travel distance at its perimeter mid-point, where it is perpendicular to its axis' center point, is 7.9 inches from its closed to open positions. The discs are made of sheet iron to be attractive to magnets and are protected with anti-corrosive paint.

Reference FIG. 3/5:

This shows the water outlet valve's left and right actuating levers, 74 and 76. These are made of stainless steel. They are 10 inches long and one-half inch square in shape. These are drilled at their centers to fit over the disc's protruding axle 67 ends. The axle ends extend 1.875 inches beyond the valve's wall 60, to provide clearance for both sets of the cables 24A and 24B.

The axle 67 has its outer ends threaded. The axle 67 is equipped with flanges 81 and 83, to provide a seat for the actuating levers 74 and 76. Self-locking nuts, 84 and 86 in turn secure these levers firmly up against the flanges.

Both of the water outlet valves in tanks 10 and 46 must be centered directly beneath their float units 20A and 20B.

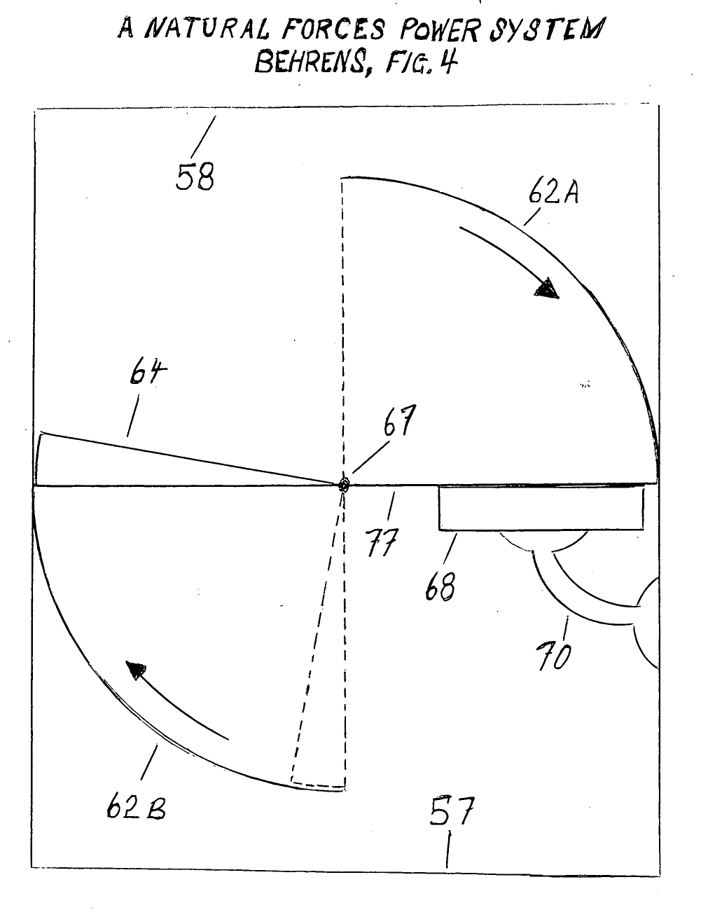

Reference FIG. 4/5:

This is a transparent side view of the water outlet valves. A Styrofoam flaring 64 is cemented to the clockwise side of the valve disc's 77 left-hand side, in its closed position. The flaring 64 slopes downward and inward from its highest level of three-eighth inch along the disc 77's perimeter one-fourth of an inch from its outer edge. It terminates next to and along the width of the axle 67, as shown in FIG. 4/5. Its slope measures 10 degrees. Reference numbers 62A and 62B show the disc's mid-perimeter's right and left side's closing paths.

Mounted to be flush with the disc 77's underside of its right half in the closed position is a permanent magnet 68. This magnet has a holding power of three pounds. This magnet is on a mounting 70, which is attached to the valve's wall 60. Reference number 58 is the valve's top opening and reference number 57 is the valve's bottom opening. Reference number 67 is the axle of the disc 77. This ends the description of FIG. 4/5.

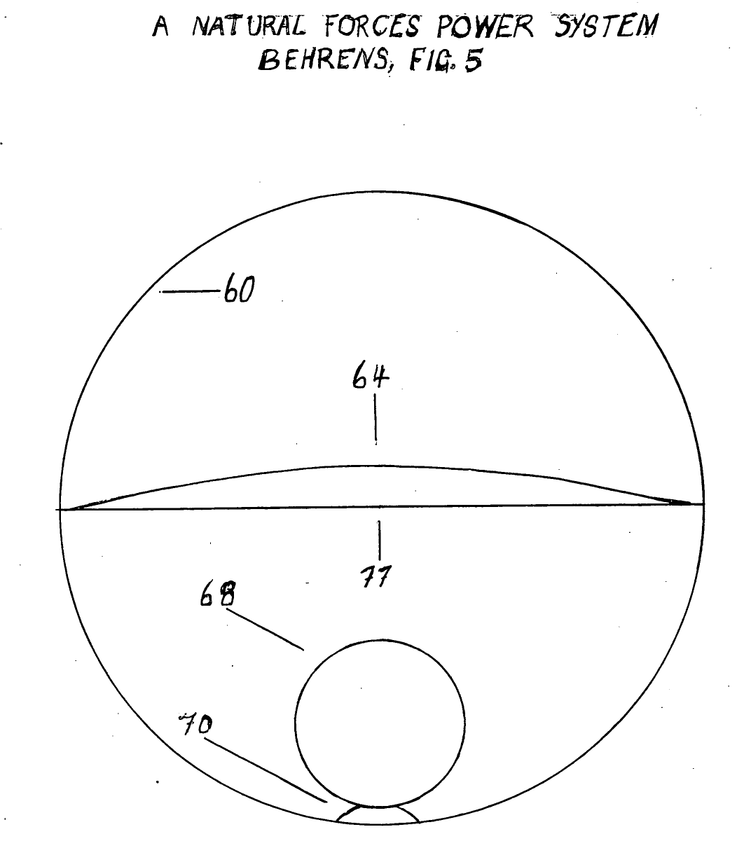

Reference FIG. 5/5:

This figure provides a view of the identical water outlet valves 26A for tank 10 and 26B for tank 46 while looking straight down into the valve in the open position. Reference number 77 is the disc with only its top edge showing. The permanently mounted magnet 68 is viewed completely exposed. Its diameter is three inches. A small part of its mounting 70 is visible. Reference number 64 is the Styrofoam flaring. The valve's circular wall is reference number 60. This ends the brief description of the drawings.

### DETAILED DESCRIPTION OF THE INVENTION

With tank 10's manhole cover secured, the system must first be filled with water. The initial filling procedures establish the residual two foot water level in tank 46 and purges out the air trapped between the water outlet valve 26B of tank 46 and the manual shut-off valve 42, which area encompasses the one-way check valve 40. Subsequent fillings for the purpose of topping off tank 10 need not be concerned with these one time initial requirements. The system is filled through its filler port 14. Please note that getting water up to the filler port is not within the scope of this invention and remains optional. First close the manual shut-off valves 38 and 42. Now fill tank 10 to overflowing. While tank 10 fills, the pipe leading from the manual shut-off valve 42 up into tank 10 also fills. Leave the filler port 14 open for one hour to dissipate any air, which may have entered the water through aeration. With the water still at the overflowing level gently screw in the filler port cap with its one-half inch bolt removed. As the cap is screwed into place the water that it replaces will flow out through the one-half inch bolt-hole. Secure the cap and reinstall the one-half inch bolt after removing the small amount of water from the space the bolt will occupy. During the filling, the water level in tank 10 gradually surpasses the float unit 20A's level whereby its buoyancy force of 17.77 pounds overcomes the permanent magnet 22A's holding force of 17.27 pounds. This causes it to rise from its initial seating location on top of the permanent magnet 22A, opening the water outlet valve 26A. This allows the water to move down to the manual shut-off valve 38. At this point open the manual shut-off valve 38 to provide a water passageway into tank 46. When the water level in tank 46 rises to the two-foot level, again close the shut-off valve 38. At this point, cautiously because of the vacuum, open the filler port 14 and again top off tank 10 to overflowing through its filler port 14, using the same procedure as before.

After the water again passes through the outlet valve 26A, open the manual shut-off valve 38. This time allow the water in tank 46 to rise up to the level whereby its water outlet valve 26B opens. Now open the manual shut-off valve 42. This opens a waterway downstream through the one-way check valve 40, the shut-off valve 42, and back up into tank 10. The air that was trapped between the water outlet valve 26B and the manual shut-off valve 42 is now purged out. The air moved up into tank 10 with the water flow from which it has to be removed. This is accomplished by first closing the shut-off valve 38, and again cautiously opening the filler port 14 to let the air escape. The filling procedure must once more be repeated through all of its steps. The opening of the manual shut-off valve 38 this time begins the system's full time operations. The forces and the mechanics moving the water are explained below.

The float unit's volume is 604.1 cubic inches. Its weight is 64.64 ounces or 4.04 pounds. The weight of water per cubic inch is 0.0361 pounds. When multiplied by 604.1 it equals 21.81 pounds. This equates to 18.5 percent of the float unit being submerged while 81.5 percent of it remains above water when floating freely.

Accordingly, 18.5 percent of the height of the float unit's 12.125 inches is 2.24 inches, which is the underwater portion of the float unit while 9.88 inches of the float unit remains above water when floating freely. Subtracting the weight of the float unit's 4.04 pounds from the 21.81 pounds weight of the water displaced, gives the float unit's force of buoyancy which is 17.77 pounds. This is based on the principal discovered by Archimedes at about 250 B.C.E., namely that the buoyant force of a unit is equal to the weight of the fluid displaced minus the weight of the unit. The force of buoyancy is one of the secondary forces used. The other is that of magnetic forces.

With the float unit 20A's release from its permanent magnet 22A's holding force, it is free to move upward on its guide bar 18A. It is 22 inches from the base that the float unit rests on to the ceiling of compartment 12. Subtracting the height of the float unit from this length leaves 9.875 inches of travel to the top. This figure nearly coincides with the float unit's free-floating portion above water, which is also its limit of rising.

Due to the one-inch of slack built into the cable 24A, the float unit first frees itself from its holding magnet before engaging the resistance of the water outlet valve 26A's three-pound force permanent magnet 68. The float unit's sudden up-thrust overcomes all resistance, and at the 7.9-inch travel point, the water outlet valve 26A opens. The float unit's rise continues toward the compartment 12 ceiling, keeping a short-term tension on the cable 24A. This short-term tension enables the water outlet valve 26A's disc 77 side with the Styrofoam flaring 64 sufficient time to acquire the needed water flow pressure to keep it open. The addition of compartment 12 to the top of tank 10 serves this travel requirement well. It provides a receptor for most of the float unit whereby its actions have no immediate affect on the main body of water in tank 10 and vice versa.

Due to water outlet valve 26A's underwater location its disc operation is not affected by the weight of the water above it. According to Pascal's law all points at the same depth in static liquid have the same head and are therefore at the same pressure. In other words, the pressure beneath the valve disc is equal to the pressure above it.

With the system's operation started the water begins to flow with an initial static head pressure of 1,089 pounds to the turbine 32. It ends with a static head pressure of 748.7 pounds. Its average static head pressure is 918.9 pounds. These figures are based on the following by using the formula for getting the volume of a cylinder. The cylinder in this case is the 10-inch circular pipe to the turbine 32. The initial height is the distance from the main tank 10's ceiling to the turbine 32 which measures 32 feet or 384 inches. Likewise to the flow's end. The distance from the height of the two feet of water remaining in tank 10 to the turbine is 22 feet or 264 inches. The 1,089 pounds plus 748.7 equals 1,837.7 pounds divided by two gives the average of 918.9 pounds. This is a good pressure for turning the turbine. Please note that the 22-foot high water level for the flow's end is accounted for below. As the falling water enters the turbine 32 its angular motion is changed to a rotational motion for harnessing. The drive shaft 33 transfers the turbine's power to drive machinery such as a generator. As the water leaves the turbine 32 it enters tank 46 through its bottom inlet 39.

The open tank 46 water surface, measuring 336 square feet, is at all times subjected to the atmospheric pressure of 14.7 pounds per square inch (psi) at sea level. This pressure over one square foot equates to 2116.8 pounds. Twelve inches times 12 inches times 14.7 equals 2116.8 pounds. Considering that tank 46 has 336 square feet of surface, the total atmospheric pressure acting on it is enormous.

Nevertheless, tank 46 receives all of the water from tank 10 down to tank 10's two-foot water level. At that point the flow stops because the receding water in tank 10 left a Torricellian vacuum in its wake. Reference the book titled High Vacuum Engineering by Alfred E. Barrington, Prentice Hall Inc, Englewood Cliffs, N.J. 1963. The force of gravity causes the water level to drop to the 33.95-foot level, two feet above tank 10's bottom. The 33.95-foot level is the maximum that the atmospheric pressure of 14.7 psi can sustain a column of water within a sealed tank. The 22-foot figure used above was derived from this and used to calculate the final head pressure for turbine 32's operation.

That the 14.7 psi can only sustain water up to a level of 33.95 feet, while creating a vacuum above that height when leaving an elevated sealed container is calculated thus: A cubic foot of water weighs 62.4 pounds. When this weight is distributed over a square foot, that is, over 144 square inches its distributed weight equals 0.433-psi. This is the weight of a column of water one-foot high covering a square inch area. Hence, 33.95 feet times 0.433 psi equals 14.7 psi. The 33.95 figure is used for the height of tank 10's low water level of two feet as measured from the ground base at sea level.

Note too that 33.95 feet times 12 equals 407.40 inches times 0.0361 (the weight of one cubic inch of water) equals 14.7 psi. Therefore, the highest level that the normal sea level atmospheric pressure of 14.7 psi can sustain a column of water within a sealed container from which it was dropped is 33.95 feet. By the same token, the vacuum now above the two-foot water level at the height of 33.95 feet in tank 10 can not raise the water higher. Here the force of gravity and the atmospheric pressure's absence balance each other. Also, when equilibrium exists, molecules continuously evaporate and pass into a vapor state. However, at the same time other molecules condense out of the vapor. For that reason, these two processes balance one another in a vacuum without disturbing it.

The atmospheric pressure of 14.7 psi is transmitted from tank 46 via the piping through the turbine 32 to the water in tank 10. The atmospheric pressure on the tank 46's water is readily transmitted through the turbine 32 due to the standard clearance between its walls and the turbine vanes, and the one-half inch hole opening in each of theses vanes. Observe that it is only liquid pressure that is being transmitted and not the liquid itself.

As the water lowers in tank 10, the float unit 20A returns to its base. When the water level lowers to the 33.95-foot mark as measured from the ground base level, the water flow stops, leaving a water depth in tank 10 of two feet. With the absence now of water pressure against the Styrofoam flaring 64 in the water outlet valve 26A, it closes. Its closed position is securely maintained with the permanent magnet 68 until the next cycle. This ends the power phase of the operation.

I recommend the Worcester Controls Corporation, 33 Locke Drive. P.O. Box 538 Marlborough, Me., 01752-9906 for the manufacture of these specially designed identical water outlet valves 26A and 26B. This corporation has the ability to manufacture butterfly valves up to 24 inches in diameter with a working pressure range from five microns of vacuum to a maximum of 200 psi. I also recommend this source for the shut-off valves 38 and 42 and for the one-way check valve 40.

Tank 10's water capacity above the two-foot level is 21,544 gallons. This is the quanity of water that moves from tank 10 to tank 46. Combining this with tank 46's two feet of water is 26,570 gallons. Knowing tank 46's dimensions, its increased water level is calculated at 10 feet and 6.85 inches, or 126.85 inches.

The float unit 20B, similar to float unit 20A has 18.5 percent of its height submerged and 81.5 percent above water level when floating freely. This equates to 2.24 inches submerged, with 9.88 inches of it being above the water line to the nearest hundredth.

The permanent magnet's 17.27 figure divided by the float unit's figure of 17.77 gives a percentage of 97.2 percent, which, of the float unit's height of 12.125 inches is 11.78 inches. The 11.78 inch mark then is the water line on the float unit at the moment of release, that is if it is released at the point when the float unit's buoyancy of 17.27 pounds is reached to match that of the holding magnet, which is unlikely. Consider for example, the coefficient of resistance, whereby a stationary object tends to remain stationary.

Now the reserve buoyancy of one-half pound comes into play. Having a water level of 11.78 inches when the holding magnate's force of 17.27 pounds was matched left 0.345 inches above the water's surface.

Dividing the 17.77 pounds of buoyancy by 604.1 cubic inches equals 0.0294 pounds of buoyancy per cubic inch. This times 16 (ounces per pound) equals 0.4704 ounces per cubic inch. The float unit's radius of four times four is 16, times 3.1416 (pi) is 50.2656, times the height of 0.345 is 17.34 cubic inches of buoyancy remaining above the water's surface. Multiplying 17.34 cubic inches by 0.4704 ounces per cubic inch results in 8.16 ounces of buoyancy. This is the one-half pound difference between the float unit's 17.77 pounds of buoyancy and that of the permanent magnet's holding force of 17.27 pounds. Slight adjustments may be required in practice to attain the required water level in tank 46 by adjusting the permanent magnet 22B's height on the guide bar 18B.

With the float unit 20B now releasing itself from its permanent magnet base 22B with its full buoyancy force of 17.77 pounds it bounds upward toward the surface. En route, as it reaches the end of the one-inch slack in the cable, the water outlet valve 26B begins to open as its disc is freed from the holding magnet 68's three-pound force. As the float unit 20B's bottom passes its 7.9-inch mark the water outlet valve 26B is opened. The float unit 20B's full travel distance is 9.881875 inches, which is its free-floating stance. After fully opening the water outlet valve 26B, it still has 1.982 inches to rise. With the shut-off valve 42 already open, the atmospheric pressure on tank 46's water surface responds forcefully to relieve tank 10's vacuum through the opened passageway. This it can readily accomplish because of tank 46's elevated position of 18 feet above the ground level at sea level locations. It has only to move the water up to the 44.95-foot level, which is the top of the compartment 12's ceiling, from tank 46's low water level, which is 20 feet above ground. This distance is 24.95 feet, requiring a pressure of only 10.8 psi of the available 14.7 psi at sea level locations.

As the 21,544 gallons of water return to tank 10, tank 46's water outlet valve 26B closes, ending the system's recovery phase. Valve 26B closes as the water flow pressure against its Styrofoam flaring 64 stops. The flaring's buoyancy, due to its Styrofoam composition, now causes its side of the disc to rise upward. This is possible because the entire water outlet valve 26B is submerged in the minimal two feet of water of tank 46. This is similar to that of the water outlet valve 26A in tank 10. As the Styrofoam flaring 64 rises, due to its buoyancy, the opposite side of the disc 77 moves downward, and becomes securely fastened in its fully closed position by the valve's permanent magnet 68. It remains securely closed pending the following cycle of operations.

At the moment tank 46 reaches its highest water level of 28.57 feet above the base ground level, its head pressure through the 10-inch water inlet 39 to the ground level is 12.37081 psi. At the same moment tank 10's head pressure, at its low water mark of 33.95 feet above the ground level through the turbine blade holes by way of the 10-inch pipe is 14.70035 psi. Tank 10's pressure at that point is 2.32954 psi greater, ensuring a complete transfer.

The heavy surge of water entering the open passageway through the opened shut-off valve 42 requires that baffles be installed in tank 46 above the water outlet valve 26B. Their purpose is to prevent the formation of a vortex. A vortex could evolve to the extent that a clear air passage could develop in its center. Air of any appreciable volume entering the system would be detrimental to the system's operation.

Baffles, not illustrated, are to be installed over the area of the water outlet valve 26B as follows: Baffle plates are to be extended from tank 46's longitudinal sides. These are to cover 112 square feet of area beginning from the end wall near the water outlet valve. Considering the tank's 14-foot width this places the plates eight feet out from each side. Extended baffle plates from both sides are to be at intermittent levels separated one foot above one another with each overlapping its opposite side by one foot. A total of eight baffle plates are considered to be the minimum required. As tank 10's water level again reaches the level for its float unit 20A to release from the top of the permanent magnet 22A which is its nesting base, valve 26A reopens. As it opens, a new cycle begins. This and subsequent cycles now operate with both manual shut-off valves 38 and 42 already opened.

The automatic recycling, controlled internally by the two float unit's operation of the water outlet valves 26A and 26B, may continue indefinitely, provided no air enters tank 10. Regardless of good design, the intake of some air into the system may be unavoidable, particularly that due to aeration. When such entry of air eventually causes tank 10's replenishment to fall to an unacceptable level, then corrective action is to be taken. Such action falls under the purview of routine maintenance and inspection, common to all machines.

The corrective action consists of closing the manual shut-off valve 38 when the tank 10 water reaches its highest level. Valve 42 remains open during the tank 10 topping off procedure. Next, carefully open the vent on the filler port 14 to relieve tank 10's remaining vacuum. Now open the filler port 14 and top off tank 10, using the same filling process previously explained, and again start the system's operation with the re-opening of the shut-off valve 38.

The water that failed to enter tank 10, due to the intake of air, remained in tank 46, above the normal minimum two-foot water level. After the tank 10 topping off, the following cycle will experience a higher water level in tank 46. To control this excess water, the overflow port 45 has been provided. Its height in the open tank 46 is such that any water over the 10-foot and seven-inch level will flow overboard. The water so dispensed may be saved for future refilling.

The entire operation is based on the extraordinary forces of gravity, and that of its resulting atmospheric pressure, which is simply the weight of air on the Earth's surface. The system's design takes advantage of their limitations: The atmospheric pressure's inability to sustain a column of water beyond 33.95 feet at sea level under the described conditions, and gravity's inability to move water down from within a sealed tank where its water's wake has left a Torricellian vacuum. This ends the detailed description of the system's drawings and operation.

### Reference Numerals in Drawings

FIG. 1: A perspective view of the overall system:
10 Sealed water tank
12 Top compartment.
14 Filler port.
16 Manhole.
18A Guide bar, tank 10.
20A Float unit, tank 10.
22A Permanent magnet, tank 10.
24A Steel cable, tank 10.
25A Turnbuckle, tank 10.
26A Water outlet valve, tank 10.
28 Water inlet port, tank 10.
30 Piping.
31A though 31N, Flange pipe couplings.
32 Turbine.
33 Drive shaft.
34 Drive shaft outlet.
36 Drive shaft's splined end.
37A through 37E, Pipe elbows.
38 Lower manual shut off valve.
39 Water inlet, tank 46.
40 One-way check valve.
42 Upper manual shut-off valve.
26B Water outlet valve, tank 46.
24B Steel cable, tank 46.
22B Permanent magnet, tank 46.
25B Turnbuckle, tank 46.
20B Float unit, tank 46.
18B Guide bar, tank 46.
44 Guide bar support frame, tank 46.
45 Overflow port.
46 Open water tank.

FIG. 2. Details of the identical float units 20A and 20B:
48 Styrofoam cylinder.
52A Steel pin left side.
52B Steel pin. right side.
50 Iron disc.
51 Threaded insert.
54 Washer.
56 Retaining nut.
FIGS. 3,4 and 5. Different views of the identical water outlet valves 26A and 26B:
58 Valve's open top.
57 Valve's open bottom
60 Valve's circular wall.
62A Valve disc's mid-perimeter path on closing, right side.
62B Valve disc's mid-perimeter path on closing, left side.
64 Styrofoam flaring.
67 Diametrical axle.
68 Valve's magnet.
70 Valve magnet's mounting.
74 Valve's left actuating lever.
76 Valve's right actuating lever.
77 Valve disc.
78 Left sealed bearing.
80 Right sealed bearing.
81 Left axle flange.
83 Right axle flange.
84 Self-locking nut left side.
86 Self-locking nut right side.

I claim:

1. A system alternately utilizing the forces of gravity and the atmospheric pressure as a means of producing power, comprising:
an elevated sealed water tank,
an elevated open water tank lower than said elevated sealed water tank,
piping, circuitously connecting said elevated sealed water tank with said elevated open water tank.
means downstream from said elevated sealed water tank whereby the angular water flow is converted to a rotational flow for harnessing.
a water outlet valve for both said elevated sealed water tank and said elevated open water tank, controlled from within.
means of timely opening and closing each said water outlet valve according to a predetermined water level in its respective tank,
a one-way check valve in said piping to prevent a reverse water flow.
and two water shut-off valves within said piping, whereby the system's operation is started and stopped.
